(19) United States
(12) Patent Application Publication
(10) Pub. No.: US 2019/0126569 A1
(43) Pub. Date: May 2, 2019

(54) PROCESS FOR MANUFACTURING A COMPOSITE MATERIAL PART

(71) Applicant: FAURECIA AUTOMOTIVE COMPOSITES, NANTERRE (FR)

(72) Inventor: Thierry RENAULT, DINARD (FR)

(21) Appl. No.: 16/170,458

(22) Filed: Oct. 25, 2018

(30) Foreign Application Priority Data
Oct. 26, 2017 (FR) 1760118
Oct. 26, 2017 (FR) 1760119

(51) Int. Cl. B29C 70/34; B29C 70/54

(52) U.S. Cl. CPC B29C 70/345; B29C 70/54

(57) ABSTRACT

A process for manufacturing at least one composite material part including a matrix made from a thermoplastic material and at least one reinforcing layer comprising fibers includes the following successive steps. At least a reinforcing layer and a thermoplastic material are arranged in a molding cavity of a mold or a first shaping tool that is movable between an open position and a closed position. A closed molding cavity or a closed first shaping tool is heated to a first temperature above a melting temperature of the thermoplastic material. A first pressure is applied in the molding cavity or in the first shaping tool such that the thermoplastic material impregnates the fibers of the reinforcing layer in order to form a non-consolidated part. The non-consolidated part is cooled to a second temperature below the melting temperature of the thermoplastic material. A second pressure is applied on the non-consolidated part such that the non-consolidated part consolidates.

### CROSS-REFERENCE TO RELATED APPLICATIONS

This application claims priority to FR 1760118, filed 26 Oct. 2017, and FR 1760119, filed 26 Oct. 2017.

### FIELD OF INVENTION

The present invention relates to a process for manufacturing at least one composite material part including a matrix made from a thermoplastic material and at least one reinforcing layer comprising fibers.

### BACKGROUND OF THE INVENTION

Composite material manufacturing processes are known. Such a process is in particular used to manufacture composite parts for motor vehicles.

One traditional solution consists of using a pre-impregnated reinforcing element manufactured before manufacturing the part. The preimpregnated reinforcing element is, for example, a fabric of reinforcing fibers impregnated with a thermoplastic material. The preimpregnated reinforcing elements are traditionally manufactured continuously in a double-strip press, in which a reinforcing fiber fabric strip and a thermoplastic material strip circulate. The press comprises a heated zone, in which the two strips are placed in contact and arranged to melt the thermoplastic material to impregnate the fabric with the thermoplastic material, and a second cold zone that makes it possible to consolidate the reinforcing element. This process makes it possible to manufacture only plates of preimpregnated material having a constant thickness and a single fiber orientation or a single fiber weave. These plates are next cut to the shape of parts to be manufactured and shaped.

In one alternative, the thermoplastic material and the reinforcing fiber layer are first arranged in a mold to heat the plastic material so that it impregnates the fibers, then the part is cooled in order to consolidate it. Such a production process thus requires heating the mold, then allowing each part produced by said mold to cool, which considerably increases the production times, which may reach up to several hours, in particular due to the time needed to heat the mold again, which has cooled during the production of the previous part.

Such a production process thus requires heating the mold, then allowing each part produced by said mold to cool, which considerably increases the production times, in particular due to the time needed to heat the mold again, which has cooled during the production of the previous part.

### SUMMARY OF THE INVENTION

One aim of the invention is to offset this drawback by proposing a process for manufacturing a composite material part that is fast while guaranteeing its final quality.

To that end, the invention relates to a process for manufacturing at least one composite material part including a matrix made from a thermoplastic material and at least one reinforcing layer comprising fibers, the process comprising the following successive steps:

(a) arranging at least a reinforcing layer and a thermoplastic material in a molding cavity of a mold or a first shaping tool movable between an open position and a closed position;

(b) heating a closed molding cavity or a closed first shaping tool to a first temperature above the melting temperature of the thermoplastic material, a first pressure being applied in said molding cavity or in the first shaping tool such that the thermoplastic material impregnates the fibers of the reinforcing layer in order to form a non-consolidated part; and

(c) cooling the non-consolidated part to a second temperature below the melting temperature of the thermoplastic material, a second pressure being applied on the non-consolidated part such that the non-consolidated part consolidates.

The manufacturing process according to the invention in particular makes it possible to accelerate the process of manufacturing a composite material part by reducing the time necessary between two production cycles. Indeed, the manufacturing process makes it possible to heat and cool the molding cavity actively, and therefore a part arranged in the mold more quickly, or to leave the first shaping tool at the desired temperature without having to cool it, then heat it again when producing two successive parts.

According to specific embodiments of the invention, the process further has one or more of the following features, considered alone or according to any technically possible combination(s):
the manufacturing process comprises providing a second shaping tool separate from the first shaping tool, said second shaping tool having a temperature below the melting temperature of the thermoplastic material,

step (c) being carried out in the second shaping tool,

the process further comprising, between steps (b) and (c), a step ((3) for opening the first shaping tool and transferring the non-consolidated part to the second shaping tool,

the process further comprising, after step (c), a step (d) for removing a consolidated part from the second shaping tool;
steps (b) and (c) are carried out in the same molding cavity, said molding cavity having a shape of the part to be manufactured,

step (c) comprising cooling the molding cavity using a cooling device when the non-consolidated part is in the molding cavity, step (c) also comprising applying the second pressure in said molding cavity, the non-consolidated part consolidating in the molding cavity during step (c),

the process further comprising, after step (c), a step (d) for stripping the consolidated part from the mold;
before arranging the reinforcing layer and the thermoplastic material in the molding cavity or the first shaping tool, the process comprises a step for cutting the reinforcing layer to the shape of at least a portion of the part to be manufactured;
the fibers of the reinforcing layer extend along at least two different orientations;
the composite material part comprises several reinforcing layers, the process comprising, before arranging the reinforcing layers and the thermoplastic material in the molding cavity or the first shaping tool, the following successive steps:
cutting the reinforcing layers such that each one has dimensions smaller than or equal to the corresponding dimensions of the molding cavity or the part to be manufactured; and
stacking the cut reinforcing layers and attaching them to one another;
the cut reinforcing layers have at least two different orientations of fibers or at least two different textile weaves;
before arranging the reinforcing layers and the thermoplastic material in the molding cavity or the first shaping tool, the process comprises a step for preheating the materials;
the first shaping tool comprises the first molding cavity and the second shaping tool comprises a second molding cavity having the shape of the part to be manufactured;
the mold or the second shaping tool comprises a device for injecting a molding material, the process comprising a step for injecting a molding material on the consolidated part before it is stripped from the mold or in the second molding cavity on the consolidated part before it is removed from the second shaping tool;
the first pressure applied in the molding cavity is between 1 bar and 60 bars, and is advantageously between 2 bars and 10 bars;
the heating duration in the molding cavity or cooling duration in the molding cavity to reach the first temperature or the second temperature is between 20 s and 80 s, and is advantageously between 30 s and 60 s;
the value of the first pressure in the molding cavity varies temporarily, advantageously varies as a ramp, and preferably by the following function: 2 bars for 0-30 s, 10 bars for 20 s-40 s, 2 bars for 0-10 s and 10 bars for 0-20 s;
the value of the second pressure applied in the molding cavity is greater than or equal to the minimum value of the first pressure applied in the molding cavity;
the molding cavity or the first molding cavity has the developed or non-developed form of at least a portion of the part to be manufactured;
the reinforcing layer and the thermoplastic material are arranged in a molding cavity of a mold, said mold being arranged in the first shaping tool, then in the second shaping tool;
several parts are manufactured, the first shaping tool being kept at the temperature higher than the melting temperature of the thermoplastic material between the outlet of a first non-consolidated part of the first shaping tool, and the arrangement of at least one reinforcing layer and a thermoplastic material in the first shaping tool for the production of a second non-consolidated part;
a pressure greater than the ambient pressure is applied in the second shaping tool;
the first pressure in the first shaping tool is below 15 bars, and is preferably below 10 bars; and
the time of a cycle spent in the first shaping tool and/or the second shaping tool is between 40 s and 70 s, and is advantageously equal to 55 s.

### BRIEF DESCRIPTION OF THE DRAWINGS

Other features and advantages of the invention will appear upon reading the following description, provided solely as an example and done in reference to the appended drawings, in which:

FIG. 1 is a perspective view of a finished part obtained by a process according to the invention;

FIG. 2 is an illustration of the steps for obtaining reinforcing layers according to the invention;

FIG. 3 is a top view illustrating the cutting of the reinforcing layers;

FIGS. 4 to 5 are schematic illustrations of the mold during successive steps of the manufacturing process according to a first embodiment of the invention;

FIG. 6 is a schematic illustration of an example of stacking of reinforcing and composite material layers according to the invention; and

FIGS. 7 to 11 are schematic illustrations of shaping tools during successive steps of the manufacturing process according to a second embodiment of the invention.

### DETAILED DESCRIPTION

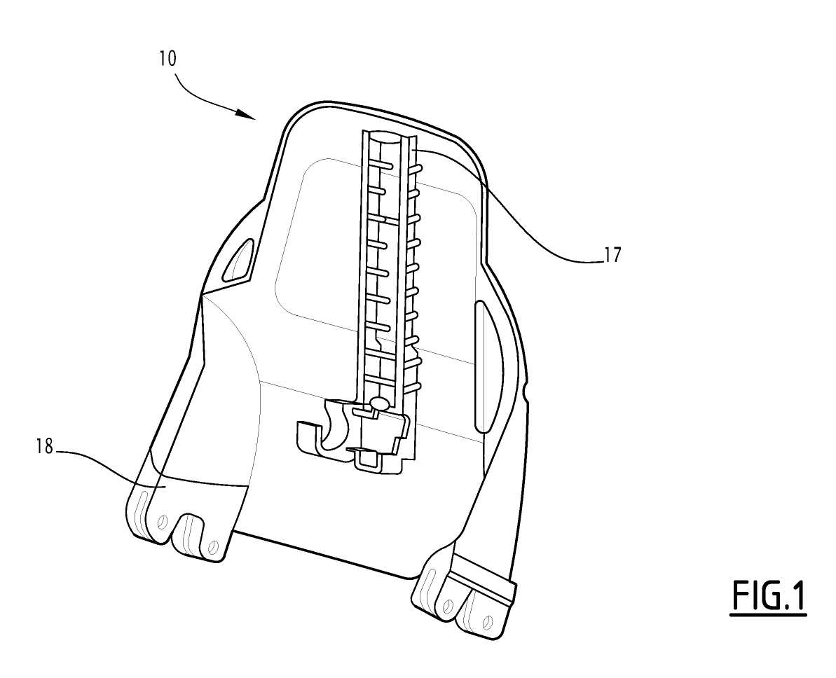

The process according to the invention is suitable for manufacturing composite material parts, for example a motor vehicle seat part as shown in FIG. 1. The part 10 includes a matrix 12 made from a thermoplastic material 13, and at least one reinforcing layer 14 comprising fibers 16.

The matrix 12 is made from polypropylene (PP), polyamide (PA), polyethylene terephthalate (PET) or another thermoplastic.

The fibers 16 of the reinforcing layer 14 are for example glass fibers, or carbon fibers, aramid fibers, natural fibers or the like. The reinforcing layer 14 may also comprise a mixture of said fibers. Such fibers are chosen to reinforce the part, which for example makes it possible to reduce its thickness while preserving its mechanical properties. Thus, the composite material part 10 is made lighter relative to a part made solely from plastic material while having satisfactory mechanical properties. The layer 14 may also be semi-impregnated with reinforcing fibers including a thermoplastic matrix 12, for example a fabric of reinforcing fibers powdered with a thermoplastic powder fixed on the reinforcing fibers, or a fabric with fibers mixed with reinforcing fibers and thermoplastic fibers, or co-woven with reinforcing fibers and thermoplastic fibers. All of these materials have the advantage of not being consolidated and are therefore applicable on a complex shape, and in particular on a non-developable shape so as to marry said complex shape.

As shown in FIG. 1, the part 10 for example has a three-dimensional shape, the body of which is formed by the reinforcing layer 14 impregnated by the matrix 12. Additional parts can be overmolded on the body, such as ribs 17 and/or fastening zones 18.

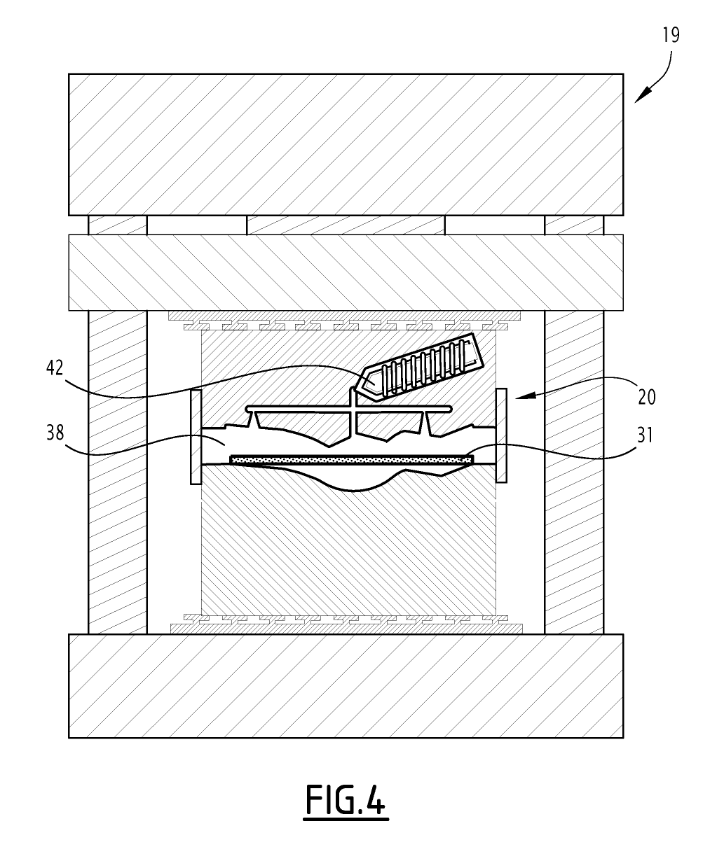

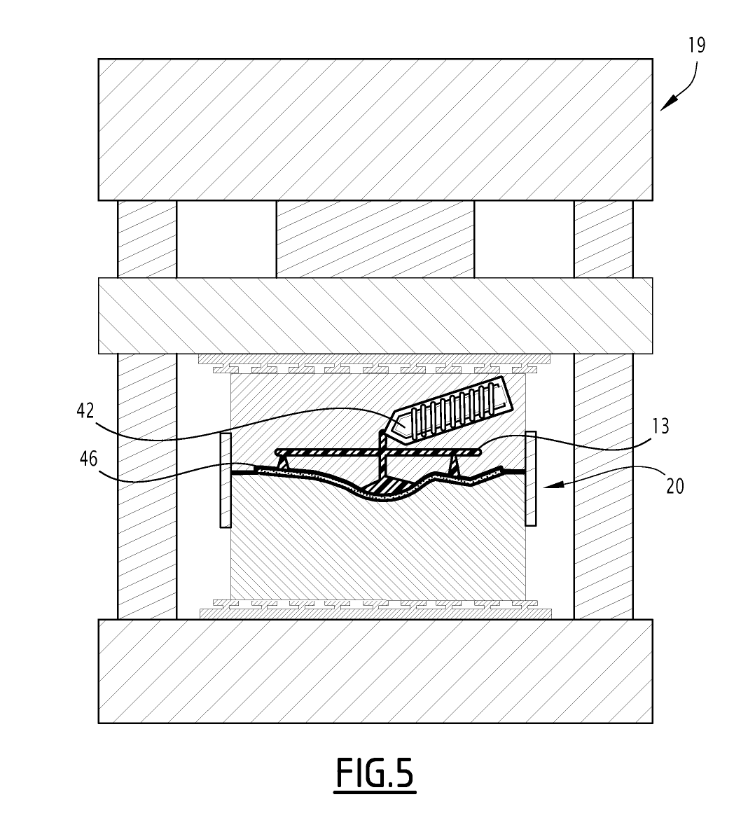

According to a first embodiment of the invention shown in FIGS. 4 and 5, each part 10 is produced in a shaping device 19 comprising a mold 20. The mold 20 is movable between an open position, in which the material(s) of the matrix 12 and the material(s) of the reinforcing layer(s) 14 can be arranged in the mold 20 and a closed position in which the mold 20 acts on said materials 12, 14 in order to form the part 10 to be produced.

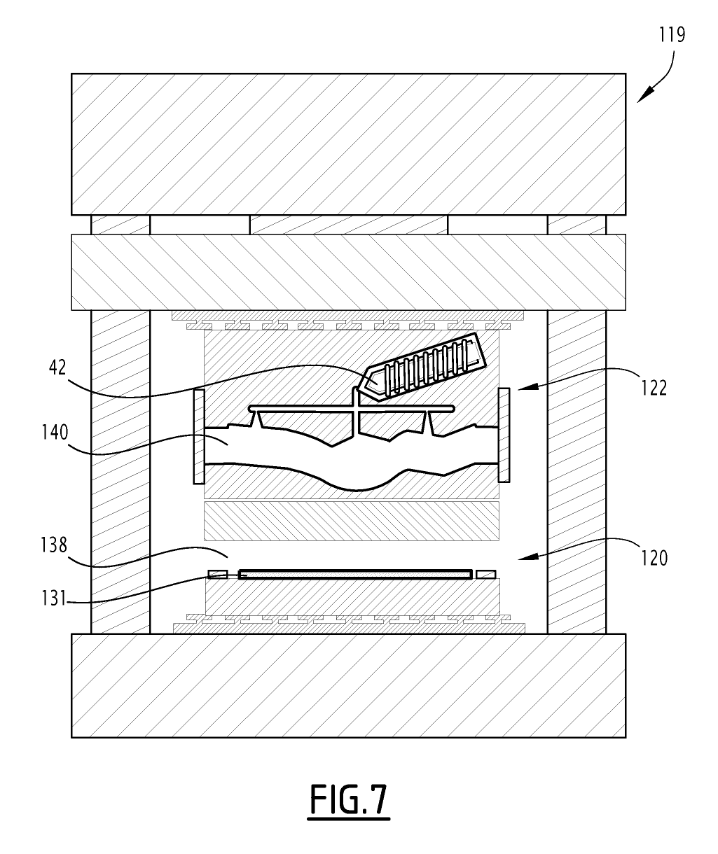

According to a second embodiment of the invention shown in FIGS. 7 to 11, each part 10 is produced in a shaping device 119 comprising a first shaping tool 120 and a second shaping tool 122. The first and second shaping tools 120, 122 are movable between an open position in which the material(s) of the matrix 12 and the material(s) of the reinforcing layer(s) 14 can be arranged in the shaping tools 120, 122, and a closed position in which the shaping tools 120, 122 act on the materials 12, 14 in order to form the part 10 to be produced.

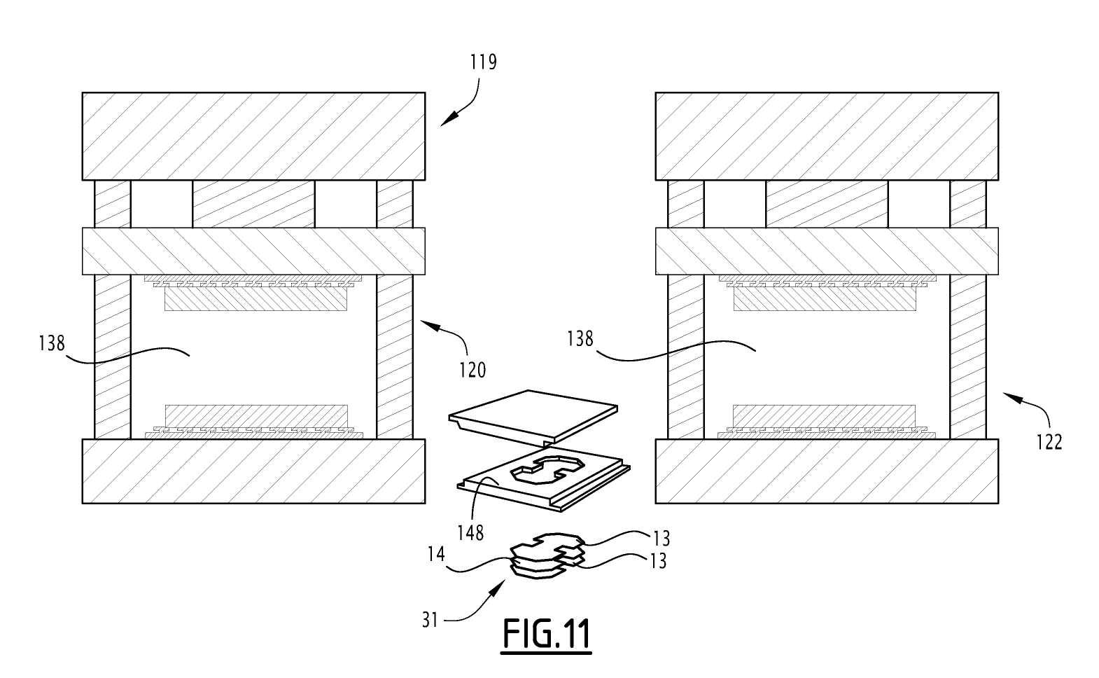

According to the embodiment shown in FIGS. 7 to 10, the shaping tools 120, 122 are molds. The molds are advantageously isothermal molds. In an alternative shown in FIG. 11, the shaping molds 120, 122 are presses with heating plates suitable for receiving at least one mold.

In reference to FIGS. 4 and 5, the different steps of the process for manufacturing a part 10 with the mold 20 will now be described.

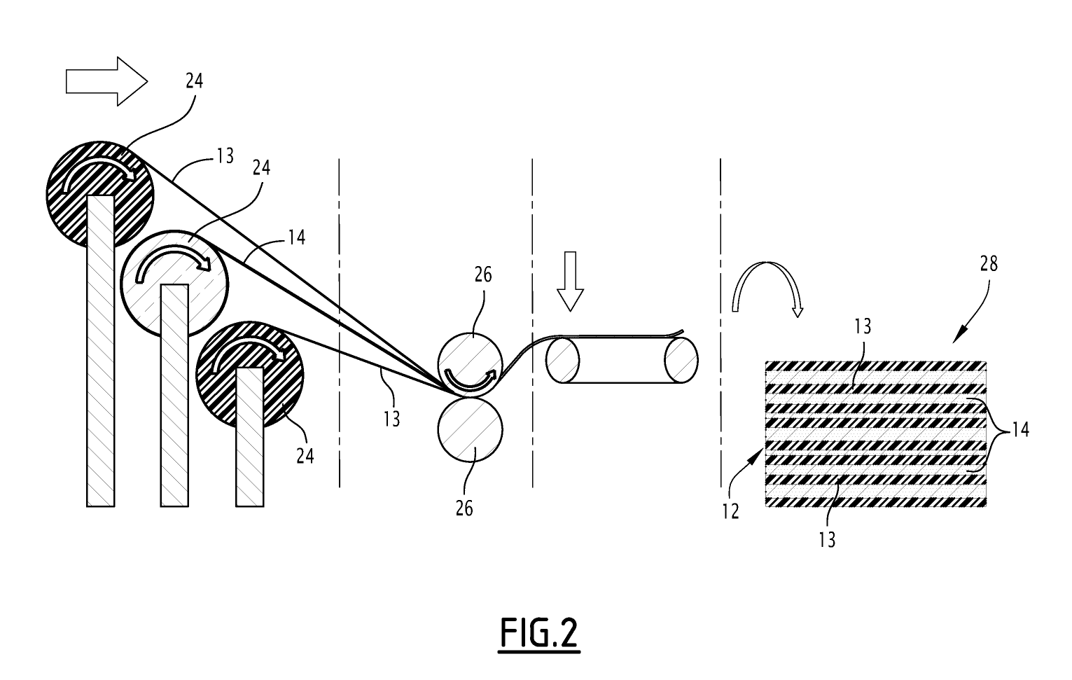

According to one embodiment and in reference to FIG. 2, first, a reinforcing layer 14 and layers of thermoplastic material 13 are unwound from storage rolls 24 and positioned on one another, the reinforcing layer 14 for example being sandwiched between the layers of thermoplastic material 13. They are next passed between two hot rollers 26 that apply a pressure on the layers while heating them in order to form a pile 28 from the reinforcing layer 14 and layers of thermoplastic material 13. According to one alternative, the pile 28 comprises several reinforcing layers 14 and layers of thermoplastic material 13, for example arranged alternating on one another.

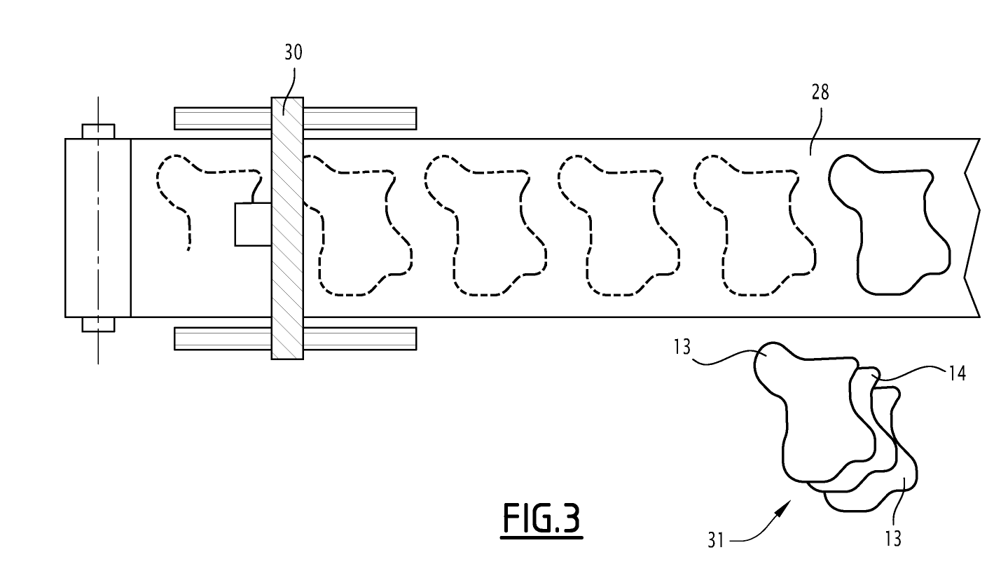

In reference to FIG. 3, the pile 28 is next cut by a cutting device 30 into several complexes 31 each formed by a part of the pile 28 and comprising at least a reinforcing layer 14 and a layer of thermoplastic material 13. The pile 28 can also be made up of layers of mixed materials containing reinforcing fibers, and a thermoplastic material for example in the form of mixed reinforcing fibers, or co-woven fabrics from reinforcing fibers and thermoplastic fibers.

The pile 28 can also be made up of fabrics from reinforcing fibers powdered with a thermoplastic matrix.

The cutting device 30 is suitable for cutting the complexes 31 such that each of said complexes 31 has a dimension smaller than or equal to a corresponding dimension of the part 10 to be manufactured. The cut complex 31 advantageously has the shape of the part 10 to be manufactured. In one alternative, the complex 31 is punched to the shape of the part 10 to be manufactured. This cutting in particular makes it possible to reduce waste, since the thermoplastic material 13 outside the cutouts can be recycled for future manufacturing operations. Indeed, in some known processes, the cutting out of the pieces of composite material is done after impregnation of the fibers by the matrix. In this case, the scrap material is made up of already-impregnated fibers, this scrap material not being reusable.

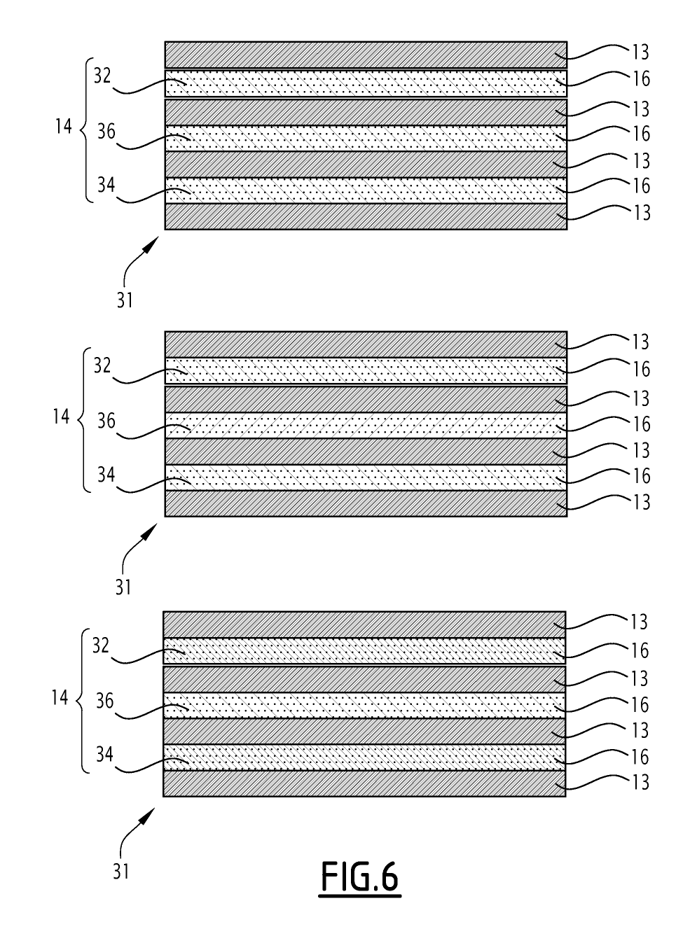

FIG. 6 illustrates different configurations of the reinforcing layers 14 in a complex 31.

In the configuration shown at the top of FIG. 6, the cut complexes 31 comprise a first 32, a second 34 and a third 36 reinforcing layer, said three layers including glass fibers 16 that are advantageously a mixture of glass fibers 16 extending in a first orientation and fibers 16 extending in a second orientation substantially perpendicular to said first orientation. Each reinforcing layer 32, 34, 36 is for example arranged between two layers of thermoplastic material 13. In one alternative, the glass fibers 16 of the first, second and third reinforcing layers 32, 34 and 36 extend only in the first orientation. In another alternative, the glass fibers 16 of the first, second and third reinforcing layers 32, 34 and 36 extend only in the second orientation.

In another configuration shown in the middle of FIG. 6, the cut complexes 31 comprise a first 32 and a second 34 reinforcing layer, said two layers including glass fibers 16 that are advantageously a mixture of glass fibers 16 extending in a first orientation and fibers 16 extending in a second orientation substantially perpendicular to said first orientation. In one alternative, the glass fibers 16 of the first and second reinforcing layers 32, 34 extend only in the first orientation. In another alternative, the fibers 16 of the first and second reinforcing layers 32, 34 extend only in the second orientation. Between the first and second reinforcing layers 32 and 34, a third reinforcing layer 36 is arranged including glass fibers 16 that are advantageously a mixture of fibers 16 extending in a third orientation that has an angle of 45° relative to the first orientation and glass fibers 16 extending in a fourth orientation substantially perpendicular to said third orientation. In one alternative, the glass fibers 16 of the third reinforcing layer 36 extend only in the third orientation. In another alternative, the glass fibers 16 of the third reinforcing layer 36 extend only in the fourth orientation. Each reinforcing layer 32, 34, 36 is for example arranged between two layers of thermoplastic material 13. It is also possible to use reinforcing layers having unidirectional woven fibers, non-crimp fibers, or layers made from glass fibers having random orientations.

In still another configuration shown at the bottom of FIG. 6, the cut complexes 31 comprise a first 32 and a second 34 reinforcing layer including carbon fibers 16. The first and second layers 32 and 34 are advantageously each a mixture of carbon fibers 16 extending in a first orientation and carbon fibers 16 extending in a second orientation substantially perpendicular to said first orientation. In one alternative, the carbon fibers 16 of the first and second layers 32 and 34 extend only in the first orientation. In another alternative, the carbon fibers 16 of the first and second layers 32 and 34 extend only in the second orientation. Between the first and second reinforcing layers 32 and 34, a third reinforcing layer 36 is arranged including glass fibers 16 that are advantageously a mixture of glass fibers 16 extending in said first orientation and glass fibers 16 extending in said second orientation. In one alternative, the glass fibers 16 of the third layer 36 extend only in said first orientation. In another alternative, the glass fibers 16 of the third layer 36 extend only in said second orientation. Each reinforcing layer 32, 34, 36 is for example arranged between two layers of thermoplastic material 13.

The reinforcing layers 14 and the layers of cut thermoplastic material 13 of each complex 31 are next joined, for example by sewing or stitching, so as to secure the layers of reinforcing fibers 14 and the layers of thermoplastic material 13 locally.

According to one embodiment of the invention, before arranging the complex 31 in the mold 20 or in the first shaping tool 120, the process comprises a step for preheating the complex 31 to a temperature below the melting temperature of the composite material 13. This preheating step is, for example, carried out by passing the complex 31 in an infrared radiation furnace. Such a preheating step makes it possible to reduce the time needed to heat the complex 31 in the mold 20 or in the first shaping tool 120 and thus to reduce the cycle time in said mold 20.

According to the first embodiment of the invention and in reference to FIG. 4, the mold 20 comprises a molding cavity 38. In one alternative, the mold 20 comprises a plurality of molding cavities 38 for simultaneously producing several parts 10. There are, for example, four molding cavities 38. The surface of the molding cavities 38 is advantageously treated in order to prevent the adhesion of the thermoplastic material 13 on the surface of the molding cavity 38. The molding cavity 38, for example, has a substantially planar shape. Advantageously, the cavity 38 has the shape of the part 10 to be manufactured.

The mold 20 is heated to a temperature higher than the melting temperature of the thermoplastic material 13. It is heated by a heater or heating element incorporated into the mold 20, for example by induction, by microwaves, or by electric resistances.

In the case where the thermoplastic material 13 is PA66, the temperature of the molding cavity 38 during the heating is between 275° C. and 315° C., and is advantageously between 280° C. and 300° C.

According to one embodiment, the mold 20 also comprises a device 42 for injecting a molding material.

The mold 20 is suitable for being cooled by a cooling device. Such a device, for example, comprises pipes arranged near the molding cavity 38. A cooling fluid, for example water, circulates in the pipes in order to cool the molding cavity 38.

In the case where the thermoplastic material 13 is PA66, the cooling temperature is between 145° C. and 165° C., preferably substantially equal to 150° C., and is advantageously equal to 150° C.

As shown in FIG. 4, at least one complex 31 is arranged in the molding cavity 38, with the mold 20 being in its open position.

According to another embodiment, instead of producing a complex 31 as described above, only the reinforcing layers 14 are cut and the thermoplastic material 13 is introduced into the mold 20 in the form of a powder, for example sprayed on the reinforcing layers 14 arranged in the molding cavity 38.

Alternatively, mixed fibers or co-woven fabrics comprising thermoplastic fibers and reinforcing fibers are cut, then introduced into the mold 20.

In reference to FIG. 5, the mold 20 is closed. A first pressure is applied in the molding cavity 38 such that the thermoplastic material 13 impregnates the fibers 16 of the reinforcing layer 14 in order to form a non-consolidated part 44. The first pressure is between 1 bar and 60 bars, and is advantageously between 2 bars and 10 bars.

In one alternative, the value of the first pressure varies temporarily, advantageously varies as a ramp, and preferably by the following function: 2 bars for 0-30 seconds (s), 10 bars for 20 s-40 s, 2 bars for 0-10 s and 10 bars for 0-20 s.

The heating duration of the reinforcing layers 14 and the composite material 13 in the mold 20 is, for example, between 20 s and 80 s, and is advantageously between 30 s and 60 s.

Thus, in the molding cavity 38, the thermoplastic material 13 liquefies and impregnates the fibers 16 of the reinforcing layer(s) 14 under the effect of the heat and the pressure in the molding cavity 38. The obtained non-consolidated part 44 is flexible or plastically deformable.

Then, the mold 20 being kept closed, the molding cavity 38 is actively cooled in order to consolidate the non-consolidated part 44. Actively means that the cooling device of the mold 20 is used in order to accelerate the cooling of the non-consolidated part 44 located in the molding cavity 38.

The mold 20 is cooled to a temperature lower than the melting temperature of the thermoplastic material 13, the thermoplastic material 13 solidifies and the non-consolidated part 44 then consolidates in the molding cavity 38 and forms a consolidated part 46. Such a part has the mechanical characteristics, for example rigidity, desired for the use of the part 10.

A second pressure is applied in the molding cavity 38 during the cooling. The second pressure is greater than or equal to the first pressure. The second pressure in particular makes it possible to reduce the porosity of the thermoplastic material 13 of the non-consolidated part 44.

The cooling duration of the reinforcing layers 14 and the composite material 13 in the mold 20 is, for example, between 20 s and 80 s, and is advantageously between 30 s and 60 s.

In one alternative, before taking the consolidated part 46 out of the mold 20, the process comprises an overmolding step by using the injection device 42. This overmolding step includes injecting molding material onto the consolidated part 46 in the molding cavity 38 in order to create the shape of the desired final part without an additional step after removing the part from the mold 20. This overmolding step is, for example, used to create the reinforcing ribs 17 or fastening zones 18 on a seat of a motor vehicle.

After consolidation in the molding cavity 38, the consolidated part 46 is removed from the mold 20.

In reference to FIGS. 7 to 11, the different steps of the process for manufacturing a part 10 with the shaping tools 120, 122 according to the second embodiment will now be described.

In reference to FIG. 7, the first shaping tool 120 comprises a first molding cavity 138. In one alternative, the first shaping tool 120 comprises a plurality of first molding cavities 138 for simultaneously producing several parts 10. There are, for example, four first molding cavities 138. The surface of the first molding cavities 138 is advantageously treated by depositing a fluorinated resin layer or by depositing an organosilicon plasma layer in order to prevent the adhesion of the thermoplastic material 13 on the surface of the first molding cavity 138. The first molding cavity 138, for example, has a substantially planar shape. Advantageously, the first cavity 138 has the shape of at least a portion of the part 10 to be manufactured.

The first shaping tool 120 is heated to a temperature higher than the melting temperature of the thermoplastic material 13. It is heated by a heater or heating element incorporated into the first shaping tool 120, for example by electric resistances, infrared rays, radiation, or microwaves.

In the case where the thermoplastic material 13 is PA66, the temperature of the first molding cavity 138 is between 275° C. and 315° C., and is advantageously between 280° C. and 300° C.

The first shaping tool 120 is able to apply a first pressure in the first molding cavity 138. The first pressure is below 15 bars, and is preferably below 10 bars.

The second shaping tool 122 comprises a second molding cavity 140 and a device 42 for injecting a molding material. In one alternative, the second shaping tool 122 comprises a plurality of second molding cavities 140. The number of second molding cavities 140 is equal to the number of first molding cavities 138.

The second molding cavity 140 has the shape of at least a portion of the part 10 to be manufactured.

The second shaping tool 122 has a temperature lower than the melting temperature of the thermoplastic material 13. It is cooled by a cooling device. Such a device, for example, comprises pipes arranged near the second molding cavity 140 of the second shaping tool 122. A cooling fluid, for example water or oil, circulates in the pipes in order to cool the second molding cavity 140.

In the case where the thermoplastic material 13 is PA66, the temperature of the second molding cavity 140 is between 145° C. and 165° C., preferably substantially equal to 150° C., and is advantageously equal to 150° C.

The second shaping tool 122 is able to apply a second pressure in the second molding cavity 140. The second pressure is between 15 bar and 50 bars, advantageously between 20 bars and 30 bars.

As shown in FIG. 7, at least one complex 31 is arranged in the first molding cavity 138, with the first shaping tool 120 being in its open position.

According to another embodiment, instead of producing a complex 31 as described above, only the reinforcing layers 14 are cut and the thermoplastic material 13 is introduced into the first shaping tool 120 in the form of a powder, for example sprayed on the reinforcing layers 14 arranged in the first molding cavity 138.

Alternatively, mixed fibers or co-woven fabrics comprising thermoplastic fibers and reinforcing fibers are cut, then introduced into the first shaping tool 120.

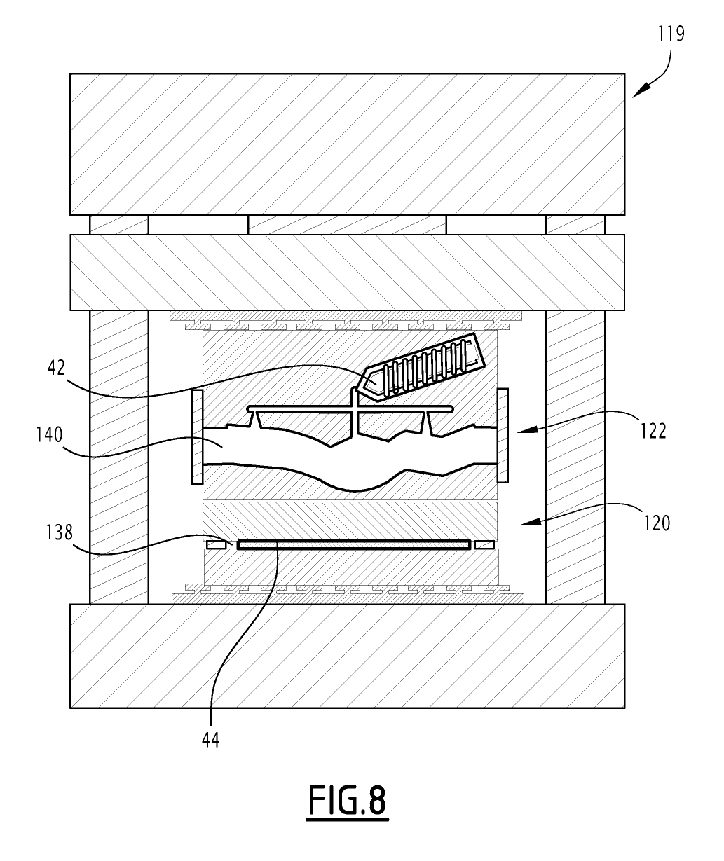

In reference to FIG. 8, the first shaping tool 120 is closed. The first pressure is applied in the first molding cavity 138 such that the thermoplastic material 13 impregnates the fibers 16 of the reinforcing layer 14 in order to form a non-consolidated part 44.

The time that the reinforcing layers 14 and the composite material 13 spend in the first shaping tool 120 is for example between 40 s and 70 s, and is advantageously equal to 55 s.

Thus, in the first molding cavity 138, the thermoplastic material 13 liquefies and impregnates the fibers 16 of the reinforcing layer(s) 14 under the effect of the heat and the pressure in the first molding cavity 138. The obtained non-consolidated part 44 is flexible or plastically deformable.

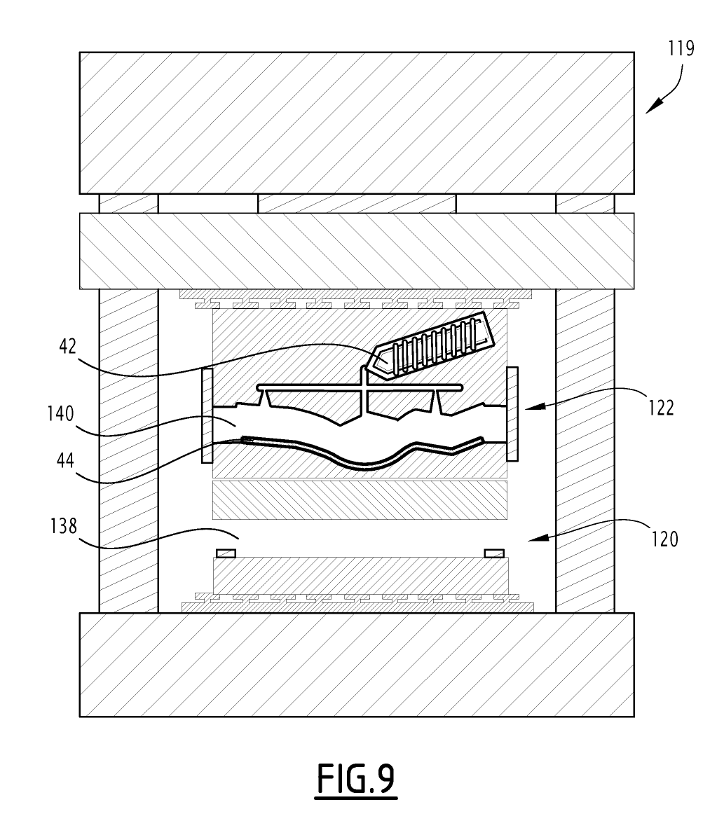

Then, the first shaping tool 120 is open, and the non-consolidated part 44 is transferred to the second shaping tool 122, as visible in FIG. 9. The transfer is quick enough for the non-consolidated part 44 to remain deformable when it enters the second molding tool 122. This transfer time is shorter than 20 s, and is preferably shorter than 10 s.

According to one preferred embodiment of the invention, successive parts 10 are manufactured continuously. The first shaping tool 120 is kept at the temperature higher than the melting temperature of the thermoplastic material 13 between the outlet of a first non-consolidated part 44 of the first shaping tool 120 and the arrangement of at least one reinforcing layer 14 and a thermoplastic material 13 in the first shaping tool 120 for the production of a second non-consolidated part 44. Thus, the first shaping tool 120 is not cooled between two opening and closing steps, and the production of the parts 10 is accelerated.

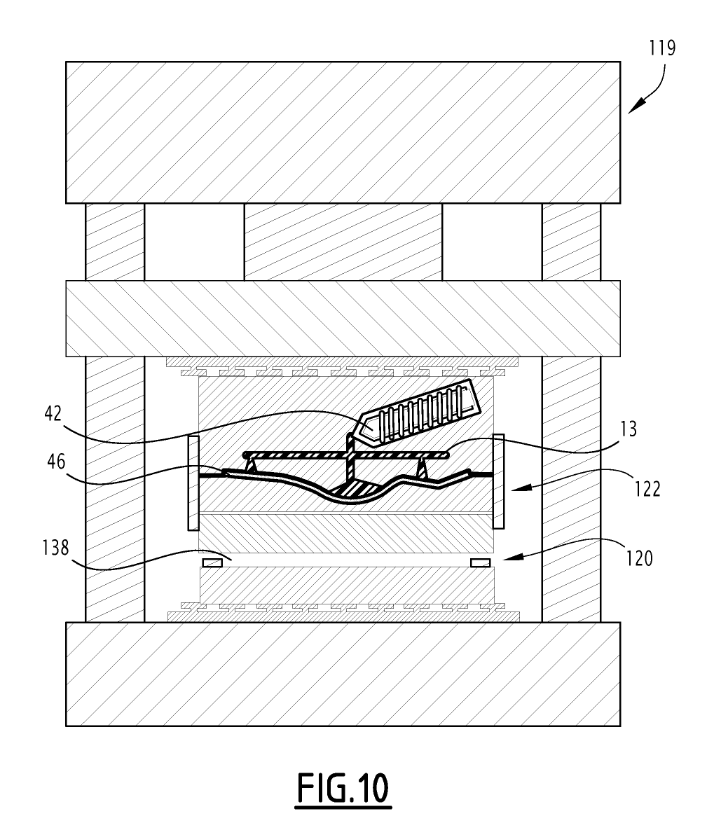

In reference to FIG. 10, the second shaping tool 122 has a temperature lower than the melting temperature of the thermoplastic material 13, the thermoplastic material 13 solidifies, and the non-consolidated part 44 then consolidates in the second molding cavity 140 and forms a consolidated part 46. Such a part has the mechanical characteristics, for example rigidity, desired for the use of the part 10.

The second pressure is applied in the second molding cavity 140. The second pressure in particular makes it possible to reduce the porosity of the thermoplastic material 13 of the non-consolidated part 44.

The time that the non-consolidated part 44 spends in the second shaping tool 122 is in particular between 40 s and 70 s, and is advantageously equal to 55 s.

In one alternative, before taking the consolidated part 46 out of the second shaping tool 122, the process comprises an overmolding step by using the injection device 42. This overmolding step includes injecting molding material onto the consolidated part 46 in the second molding cavity 122 in order to create the shape of the desired final part 10 without an additional step after removing the consolidated part 46 from the second molding tool 122. This overmolding step is for example used to create the reinforcing ribs 17 or fastening zones 18 on a seat of a motor vehicle.

After consolidation in the second molding cavity 140, the consolidated part 46 is removed from the second shaping tool 122.

In reference to FIG. 11, an alternative of the second embodiment of the process for manufacturing a part 10 with the shaping tools differs from the second embodiment in that the reinforcing layers 14 and the thermoplastic material 13 are arranged in a molding cavity 138 of a mold 148. The mold 148 is first arranged in the first shaping tool 120 to form the non-consolidated part 44, and then, without opening the mold 148, is transferred into the second shaping tool 122 in order to consolidate the non-consolidated part 44. This mode in particular makes it possible to avoid the oxidation of the part 10.

The molding cavity 138, for example, has the shape of at least a portion of the part 10 to be manufactured. Alternatively, the molding cavity 138 can be substantially planar and any shaping of the part 10 takes place during an additional shaping step after the consolidated part 46 is removed from the mold 148 removed from the second shaping tool 122.

Owing to the invention described above, the time spent on manufacturing a composite material part is reduced, which increases production efficiency. Furthermore, the process makes it possible to obtain a finished part upon leaving the mold. Such a part does not require an additional finishing step.

According to traditional processes for continuous thermoplastic preimpregnated manufacturing, it is only possible to obtain plates including a single reinforcing weave having fibers extending in one of the unique directions (for example 0/90). These traditional plates are standardized, having a unique shape, often rectangular. According to the invention, it is possible to obtain more flexibility on the thickness and orientation of the reinforcing fibers during the manufacture of the composite part. This is particularly advantageous for manufacturing components with reinforced portions.

Furthermore, it is no longer necessary to heat again, then cut the composite plate in order to obtain the finished part, which consumes less energy and creates less waste.

Although an embodiment of this invention has been disclosed, a worker of ordinary skill in this art would recognize that certain modifications would come within the scope of this invention. For that reason, the following claims should be studied to determine the true scope and content of this invention.

1. A method for manufacturing at least one composite material part comprising a matrix made from a thermoplastic material and at least one reinforcing layer comprising fibers, the method comprising the following successive steps:
(a) placing at least a reinforcing layer and a thermoplastic material in a molding cavity of a mold or of a first shaping tool movable between an open position and a closed position;
(b) heating a closed molding cavity or a closed first shaping tool to a first temperature above a melting temperature of the thermoplastic material, a first pressure being applied in the molding cavity or in the first shaping tool such that the thermoplastic material impregnates the fibers of the reinforcing layer in order to form a non-consolidated part; and
(c) cooling the non-consolidated part to a second temperature below the melting temperature of the thermoplastic material, a second pressure being applied on the non-consolidated part such that the non-consolidated part consolidates into a consolidated part.

2. The manufacturing method according to claim 1, comprising providing a second shaping tool separate from the first shaping tool, the second shaping tool having a temperature below the melting temperature of the thermoplastic material,
step (c) being carried out in the second shaping tool,
the method further comprising, between steps (b) and (c), a step ((3) for opening the first shaping tool and transferring the non-consolidated part to the second shaping tool, and
the method further comprising, after step (c), a step (d) for removing a consolidated part from the second shaping tool.

3. The manufacturing method according to claim 1, wherein steps (b) and (c) are carried out in the same molding cavity, the molding cavity having a shape of the part to be manufactured,
step (c) comprising cooling the molding cavity using a cooling device when the non-consolidated part is in the molding cavity, step (c) also comprising applying the second pressure in the molding cavity, the non-consolidated part consolidating in the molding cavity during step (c), and
the method further comprising, after step (c), a step (d) for removing the consolidated part from the mold.

4. The manufacturing method according to claim 1, wherein, before placing the reinforcing layer and the thermoplastic material in the molding cavity or the first shaping tool, the method comprises a step for cutting the reinforcing layer to a shape of at least a portion of the composite material part to be manufactured.

5. The manufacturing method according to claim 1, wherein the fibers of the reinforcing layer extend along at least two different orientations.

6. The manufacturing method according to claim 1, wherein the composite material part comprises several reinforcing layers, the method comprising, before placing the reinforcing layers and the thermoplastic material in the molding cavity or the first shaping tool, the following successive steps:
cutting the reinforcing layers such that each one has dimensions lower than or equal to corresponding dimensions of the molding cavity or the composite material part to be manufactured; and
stacking cut reinforcing layers and attaching them to one another.

7. The manufacturing method according to claim 6, wherein the cut reinforcing layers have at least two different orientations of fibers or at least two different textile weaves.

8. The manufacturing method according to claim 1, wherein, before placing the reinforcing layers and the thermoplastic material in the molding cavity or the first shaping tool, the method comprises a step for preheating the reinforcing layers and the thermoplastic material.

9. The manufacturing method according to claim 2, wherein the first shaping tool comprises a first molding cavity and the second shaping tool comprises a second molding cavity having a shape of the composite material part to be manufactured.

10. The manufacturing method according to claim 1, wherein the mold or the second shaping tool comprises an injection device of a molding material, the method comprising a step for injecting a molding material on the consolidated part before the consolidated part is removed from the mold or in the second molding cavity on the consolidated part before the consolidated part is removed from the second shaping tool.

11. The manufacturing method according to claim 1, wherein the first pressure applied in the molding cavity is between 1 bar and 60 bars.

12. The manufacturing method according to claim 1, wherein heating duration in the molding cavity or cooling duration in the molding cavity to reach the first temperature or the second temperature is between 20 s and 80 s.

13. The manufacturing method according to claim 1, wherein a value of the first pressure in the molding cavity varies according to time.

14. The manufacturing method according to claim 1, wherein a value of the second pressure applied in the molding cavity is greater than or equal to a minimum value of the first pressure applied in the molding cavity.

15. The manufacturing method according to claim 1, wherein the molding cavity or the first shaping tool has a developed or non-developed form of at least a portion of the composite material part to be manufactured.

16. The manufacturing method according to claim 2, wherein the reinforcing layer and the thermoplastic material are placed in the molding cavity of the mold, the mold being placed in the first shaping tool, then in the second shaping tool.

17. The manufacturing method according to claim 1, wherein several composite material parts are manufactured, the first shaping tool being kept at the first temperature higher than the melting temperature of the thermoplastic material between a removal of a first non-consolidated part from the first shaping tool, and a placement of at least one reinforcing layer and a thermoplastic material in the first shaping tool for the production of a second non-consolidated part.

18. The manufacturing method according to claim 2, wherein a pressure greater than an ambient pressure is applied in the second shaping tool.

19. The manufacturing method according to claim 1, wherein the first pressure in the first shaping tool is below 15 bars.

20. The manufacturing method according to claim 2, wherein a time of a cycle spent in the first shaping tool and/or the second shaping tool is between 40 s and 70 s.

21. The manufacturing method according to claim 16, wherein several composite material parts are manufactured, the first shaping tool being kept at the first temperature higher than the melting temperature of the thermoplastic material between a removal of a first non-consolidated part from the first shaping tool, and a placement of at least one reinforcing layer and a thermoplastic material in the first shaping tool for the production of a second non-consolidated part.

22. The manufacturing method according to claim 1, wherein the value of the first pressure in the molding cavity varies by the following function: 2 bars for 0-30 s, 10 bars for 20 s-40 s, 2 bars for 0-10 s and 10 bars for 0-20 s.
